(19) United States
(12) Patent Application Publication
(10) Pub. No.: US 2024/0018828 A1
(43) Pub. Date: Jan. 18, 2024

(54) SYNCHRONIZING MULTIPLE ROLLER SHUTTERS

(71) Applicants: Tser Wen Chou, Yorba Linda, CA (US); Mason Chou, Irvine, CA (US)

(72) Inventor: Tser Wen Chou, Yorba Linda, CA (US)

(21) Appl. No.: 17/938,909

(22) Filed: Sep. 6, 2022

(30) Foreign Application Priority Data
Jul. 18, 2022 (TW) 111207693

(51) Int. Cl. E06B 9/44; E06B 9/322; E06B 9/78

(52) U.S. Cl. CPC E06B 9/44; E06B 9/322; E06B 9/78; E06B 9/72

(57) ABSTRACT

An apparatus for ensuring evenness and smoothness in the operations of a roller shutter or window blind is provided. The apparatus synchronizes the torque applied across the length of the roller. The apparatus also enhances the rigidity of the roller tube without significantly increasing the cost and the weight of the roller shutter. The apparatus may include an outer tube, a rotation power source, an inner shaft, and a rotation synchronizer. The inner shaft is disposed within the outer tube. The rotation synchronizer is installed at the inner shaft to rotationally couple the inner shaft with the outer tube. A rotation power source is installed at one end of the outer tube or the inner shaft to provide power to rotate the inner shaft and the outer tube. The outer tube may be for winding the screen of a roller shutter, or a lifting or tilting cord of a horizontal blind.

### CROSS REFERENCE TO RELATED APPLICATIONS

This patent application claims the benefit and priority of Taiwanese Patent Application No. 111207693, filed on Jul. 18, 2022. Taiwanese patent applications No. 111207693 is incorporated herein by reference.

### BACKGROUND

### Technical Field

The present disclosure generally relates to mechanisms for powered operations of roller shutters.

### Description of the Related Arts

A roller shutter is a shading device that uses a roller that rotates to retract or release a screen. The rotation of the roller can be powered by a power device. Since the power device is usually attached to one end of the roller, the torque provided from that end often cannot be evenly conveyed across the entire length of the roller. The uneven torque causes the roller to retract the screen in an uneven manner, cause the screen to appear uneven. For longer rollers that are used for wider windows, the uneven retraction can seriously interfere with proper functioning of the roller shutter. Furthermore, since such a roller usually has a hallow structure, it is not sufficiently rigid and may droop or deform due to the weight of the screen. The deformed roller may further cause the retraction operation to be uneven.

To compensate for the uneven retraction of the screen, the manufacturer of the roller shutter may apply tapes to balance the screen. To compensate for the deforming of the roller, the manufacturer may increase the thickness of the roller tube. However, these methods make the roller screen more costly to manufacture and more difficult to operate due to the added weight.

### SUMMARY

Some embodiments provide an apparatus for ensuring evenness and smoothness in the operations of a roller shutter or window blind. The apparatus synchronizes the torque applied across the length of the roller. The apparatus also enhances the rigidity of the roller tube without significantly increasing the cost and the weight of the roller shutter. In some embodiments, the apparatus may include an outer tube, a rotation power source, an inner shaft, and a rotation synchronizer. The inner shaft is disposed within the outer tube. The rotation synchronizer is installed at the inner shaft to rotationally couple the inner shaft with the outer tube. A rotation power source is installed at one end of the outer tube or the inner shaft to provide power to rotate the inner shaft and the outer tube. The outer tube may be for winding the screen of a roller shutter, or a lifting or tilting cord of a horizontal blind.

In some embodiments, the rotation synchronizer comprises a rotation adaptor and a rotation driver, wherein the rotation driver is configured to recess into the rotation adaptor and receive the inner shaft. The cross-section of the inner shaft may be a square. The rotation adaptor comprises tooths that abut the interior surface of the outer tube. The rotation driver may include a protrusion that mates with a crevice of the rotation adaptor. In some embodiments, two or more rotation synchronizers are installed at the inner shaft to rotationally couple the inner shaft with the outer tube at different positions of the outer tube such that the rotations at different positions of the outer tube are synchronized.

In some embodiments, the inner shaft comprises two or more separate sections. The different sections of the inner shaft are interconnected by one or more shaft extenders that convey the rotation of the inner shaft across the different sections. At least one rotation synchronizer may be installed on each section of the inner shaft.

In some embodiments, the rotation power source is installed at one end of the outer tube, and the torque provided by the rotation power source is conveyed to the inner shaft through the rotation synchronizer. In some embodiments, the rotation power source is installed at one end of the inner shaft, and the torque provided by the rotation power source is conveyed to the outer tube through the rotation synchronizer. In some embodiments, first and second rotation synchronizers rotationally couple the inner shaft to first and second outer tubes, the first and second outer tubes belonging to different roller shutters or horizontal blinds.

The preceding Summary is intended to serve as a brief introduction to some embodiments of the disclosure. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a Summary, Detailed Description and the Drawings are provided. Moreover, the claimed subject matter is not to be limited by the illustrative details in the Summary, Detailed Description, and the Drawings, but rather is to be defined by the appended claims, because the claimed subject matter can be embodied in other specific forms without departing from the spirit of the subject matter.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a rotation synchronizer, according to an exemplary embodiment.

FIGS. 2A-C illustrate parts of a roller shutter that uses the rotation synchronizer 100 to synchronize the rotation of its roller tube.

FIGS. 3A-B illustrate a cordless roller shutter that uses the rotation synchronizer 100 to synchronize the rotation of its roller tube.

FIGS. 4A-4C illustrate a spring assisted roller shutter that uses the rotation synchronizer 100 to synchronize the rotation of its roller tube.

FIGS. 5A-C illustrate an electrically powered roller shutter that uses rotation synchronizers to synchronize the rotation of its roller tube.

FIGS. 6A-D illustrate two roller shutters that are synchronized by rotation synchronizers and an inner shaft.

FIGS. 7A-D illustrate two roller shutters that are synchronized by a shortened inner shaft.

FIGS. 8A-B illustrate a horizontal blind system that uses rotation synchronizers to perform tilting operations.

FIGS. 9A-B illustrate horizontal blind system that uses two inner shafts to synchronize the rotations of both tilting and lifting operations.

FIG. 10 illustrates another horizontal blind system that uses two inner shafts to synchronize the rotations of both tilting and lifting operations.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

To ensure evenness and smoothness in the operations of a roller shutter, some embodiments of the invention provide a mechanism for synchronizing the torque applied across the length of the roller. The mechanism also enhances the rigidity of the roller tube without significantly increasing the cost and the weight of the roller shutter. In some embodiments, the roller tube includes an outer tube, a rotation power source, an inner shaft, and a rotation synchronizer. The outer tube is for winding the screen of the roller shutter. The inner shaft is disposed within the outer tube. The rotation synchronizer is installed at the inner shaft to rotationally couple the inner shaft with the outer tube. A rotation power source is installed at one end of the outer tube or the inner shaft to provide power to rotate the inner shaft and the outer tube.

In some embodiments, two or more rotation synchronizers are installed at the inner shaft to rotationally couple the inner shaft with the outer tube at different parts of the outer tube such that the rotations of the different parts of the outer tube are synchronized. In some embodiments, a first rotation synchronizer is rotationally coupled to a first outer tube of a first roller shutter and is installed at the inner shaft. A second rotation synchronizer is rotationally coupled to a second outer tube of a second roller shutter and is installed at the inner shaft. Thus, the rotation of the first and second roller shutters are synchronized. Each rotation synchronizer includes a rotation driver and a rotation adaptor. The rotation driver is coupled to the inner shaft. The rotation adaptor fits onto the rotation driver and has an outer shape that adapts to the inside of the outer tube.

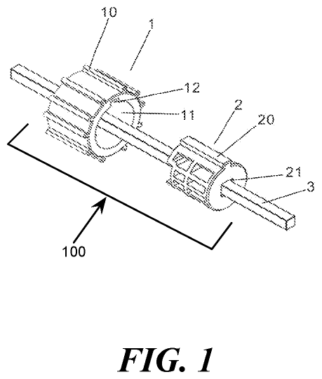

FIG. 1 illustrates a rotation synchronizer 100, according to an exemplary embodiment. As illustrated, the rotation synchronizer 100 is installed at an inner shaft 3. The rotation synchronizer 100 includes a rotation adaptor 1 and a rotation driver 2. The rotation driver 2 is configured to recess into a cavity 11 of the rotation adaptor 1, as the rotation driver 2 has a protrusion 20 that mates with a crevice 12 (part of the cavity 11) of the rotation adaptor 1. This allows the rotation adaptor 1 to mate with the rotation driver 2. The rotation driver 2 has a square tunnel 21 that can receive the inner shaft 3, whose cross-section is also square to match the shape of the tunnel 21. (The cross section of the inner shaft 3 and the tunnel 21 can have another shape, such as rectangle or another type of polygon.) Thus, the rotation of the inner shaft 3 would drive the rotation of the rotation driver 2 and the rotation adaptor 1 of the rotation synchronizer 100.

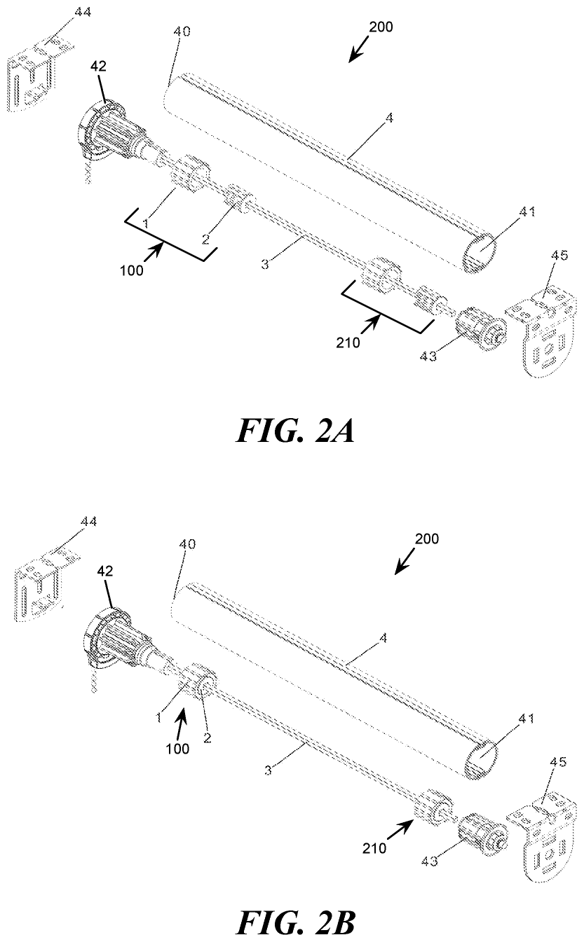

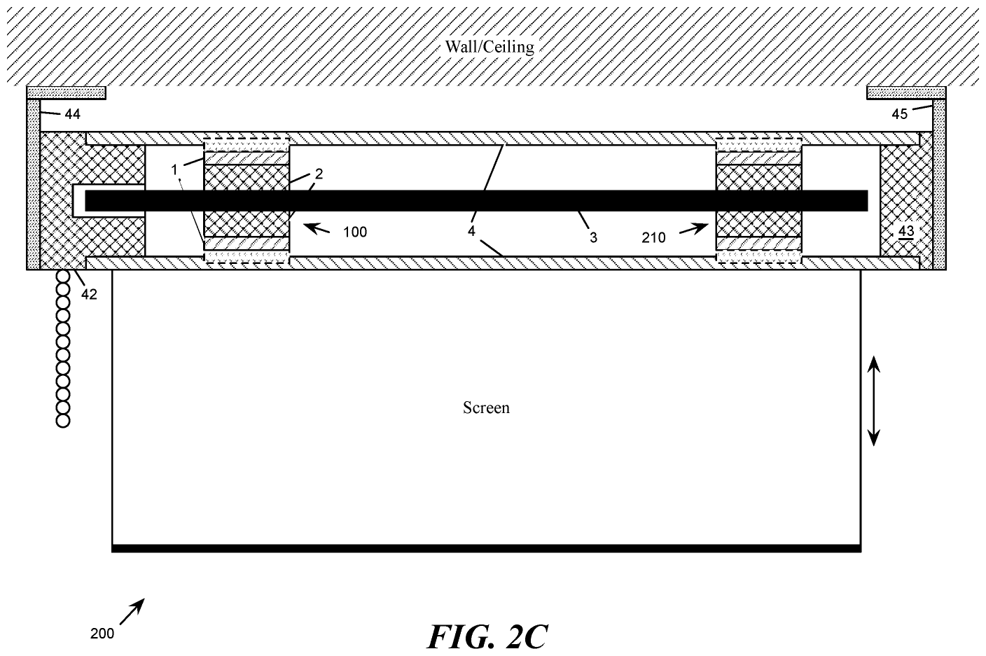

FIGS. 2A-2C illustrate parts of a roller shutter 200 that uses the rotation synchronizer 100 to synchronize the rotation of its roller tube. As illustrated, the roller tube 4 is part of a roller shutter 200. The roller tube 4 is a hallow outer tube, within which the inner shaft 3 is disposed. The rotation synchronizer 100 is installed at a first position of the inner shaft 3 while another rotation synchronizer 210 is installed at a second position of the inner shaft 3. The installation of the rotation synchronizer 100 is accomplished by fitting the rotation adaptor 1 onto the rotation driver 2. (FIG. 2B shows the rotation adaptor 1 and the drive connector 2 fitting together to form the rotation synchronizer 100.) The outer tube 4 has openings 40 and 41 at its two ends, allowing the installation of a bead chain controller 42 at the opening 40 and a tube plug 43 at the opening 41. Support brackets 44 and 45 are used to install the roller tube 4 on a window as part of a roller shutter. When a user pulls on the beads of the bead controller 42, the bead controller 42 act as a rotation power source to power the rotation of the roller tube 4 to either retract or release the screen (not illustrated) of the roller shutter 200.

FIG. 2C illustrates a cross section of the roller shutter 200 when the inner shaft and the rotation synchronizer are installed in the roller tube. As illustrated, the inner shaft 3 is disposed within the outer tube 4, and the rotation synchronizers 100 and 210 installed along the inner shaft 3 to rotationally couple the inner shaft 3 with the outer tube 4. For some embodiments, to rotationally couple two concentric elements (such as the inner shaft and the outer tube) means ensuring the angular displacement of the two concentric elements to be the substantially the same or synchronized.

The rotation synchronizers 100 and 210 are installed within the outer tube 4 along with the inner shaft 3. The exterior surface of the rotation adaptor 1 has tooths 10 at its exterior surface, allowing the rotation synchronizer 100 to abut the interior surface of the outer tube 4. Thus, a torque applied to rotate the inner shaft 3 would drive the rotation of the outer tube 4, and conversely, a torque applied to rotate the outer tube 4 would drive the rotation of the inner shaft 3. The rotation synchronizers 100 and 210 therefore rotationally couples the inner shaft 3 with the outer tube 4. Since the inner shaft 3 and the rotation synchronizers 100 and 210 are installed within the roller tube 4, the torque provided by the bead controller 42 is evenly applied to result in an even rotation of the roller tube 4.

It is worth noting that, in the example of FIGS. 2A-C, the bead chain controller 42 does not directly drive the rotation of the inner shaft 3. The inner shaft 3 is recessing into a round cavity in the bead chain controller 42, which allows the inner shaft 3 to freely rotate relative to the bead chain controller 42. The rotation of the inner shaft is driven by the rotation synchronizers 100 and 210, which are rotationally coupled to the outer tube 4. The outer tube 4 is in turn torqued by the bead chain controller 42.

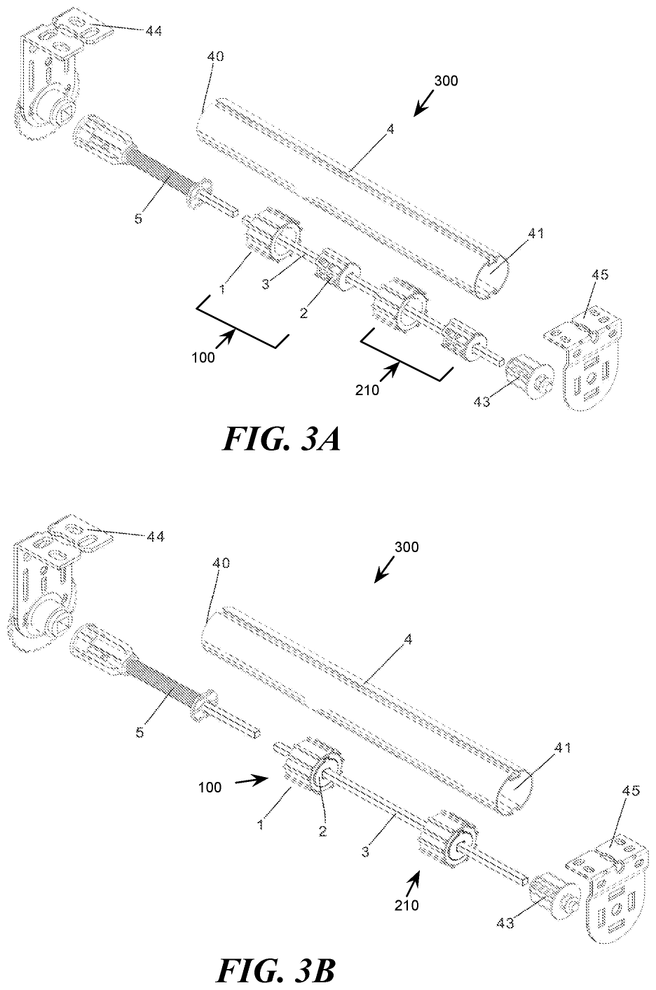

FIGS. 3A-3B illustrate a cordless roller shutter 300 that uses the rotation synchronizer 100 to synchronize the rotation of its roller tube. The cordless roller shutter 300 is similar to the roller shutter 200, except that, instead of the bead controller 42, a spring controller 5 is installed at the opening 40 and used as the rotation power source for providing the torque to rotate the roller tube 4. (FIG. 3B shows the rotation adaptor 1 and the drive connector 2 fitting together to form the rotation synchronizer 100 for the cordless roller shutter 300.) When a user pulls on the screen to cordlessly operate the roller shutter, the spring in the spring controller 5 is compressed or stretched to power the rotation of the roller tube 4.

It is worth noting that, the spring controller 5 and the inner shaft 3 are distinct components. Thus, the torque provided by the spring controller 5 does not directly drive the inner shaft 3. Rather, the spring controller 5 drives the outer tube 4, which through rotation synchronizers 100 and 210 drives the rotation of the inner shaft 3. The torque provided by the spring controller 5 is evenly to result in an even rotation of the roller tube 4 and the inner shaft 3.

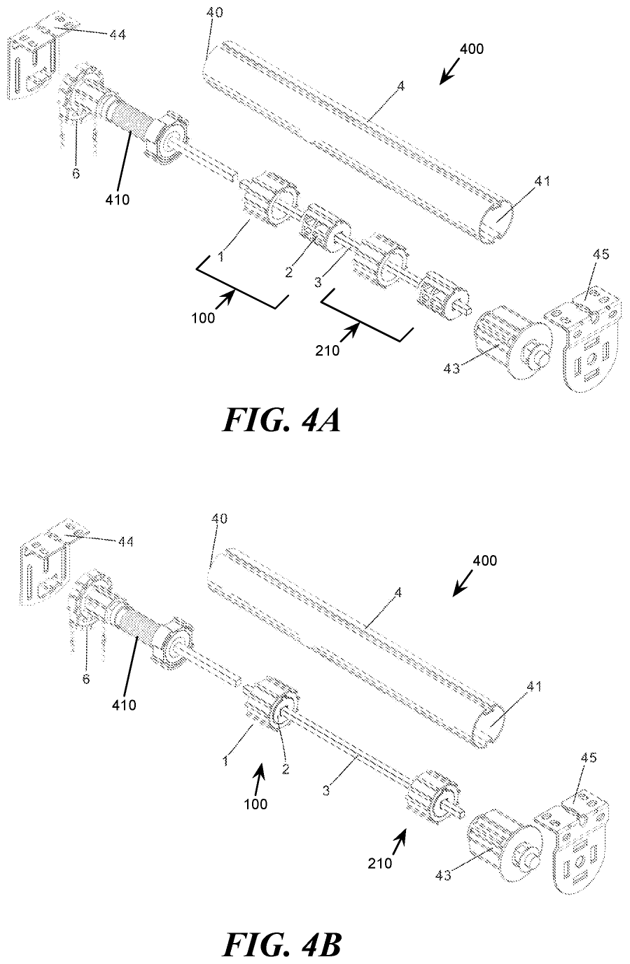

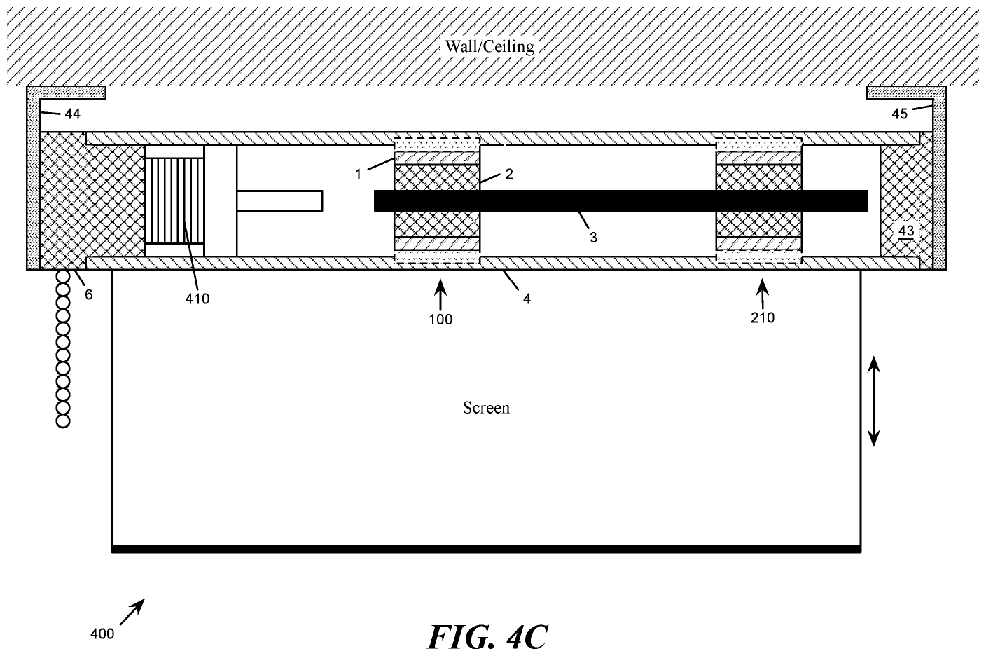

FIGS. 4A-4C illustrate a spring assisted roller shutter 400 that uses the rotation synchronizer 100 to synchronize the rotation of its roller tube. The spring assisted roller shutter 400 is similar to the cordless roller shutter 300, except that, instead of the spring controller 5, a spring assisted bead controller 6 is installed at the opening 40 and used as the rotation power source for providing the torque to rotate the roller tube 4. Also, the spring assisted bead controller 6 and the inner shaft 3 are distinct components. Thus, the torque provided by the spring assisted bead controller 6 does not directly drive the inner shaft 3. Rather, the spring assisted bead controller 6 drives the outer tube 4, which through rotation synchronizers 100 and 210 drives the rotation of the inner shaft 3. The torque provided by the spring assisted bead chain controller 6 is evenly to result in an even rotation of the roller tube 4 and the inner shaft 3.

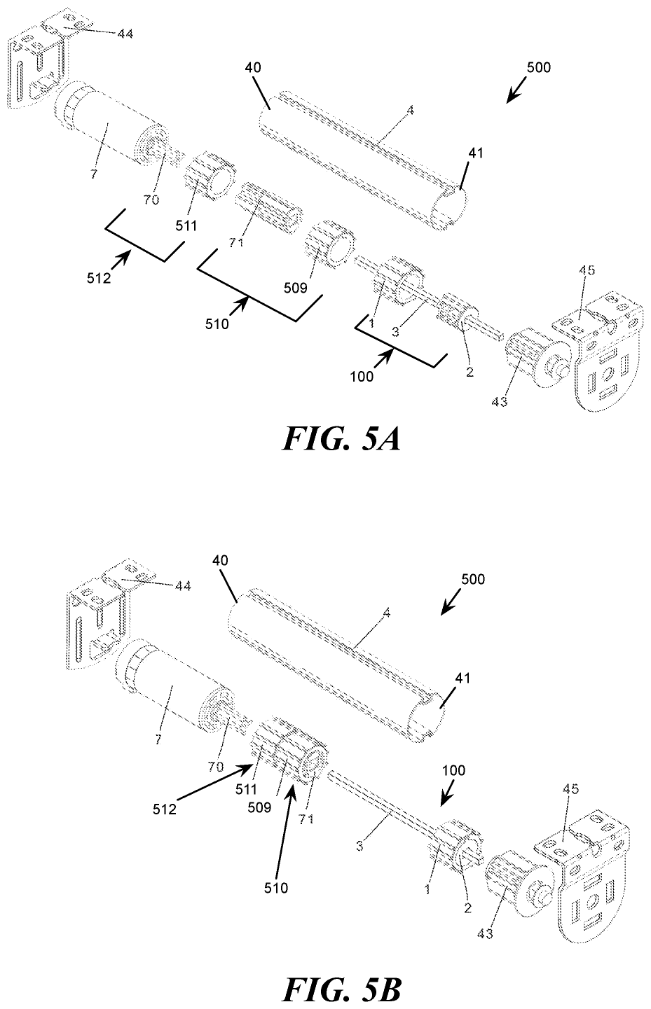

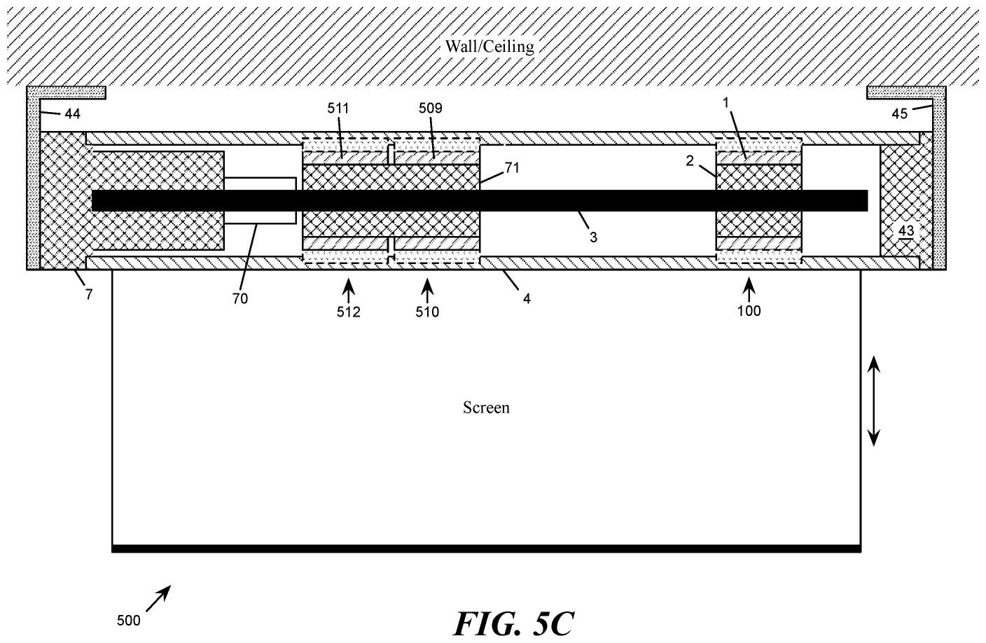

The rotation power source providing the torque to rotate the outer tube or the inner shaft can also be an electrical power source. FIGS. 5A-5C illustrates a roller shutter 500 in which the rotation power source is an electrical motor 7 while multiple rotation synchronizers are used to synchronize the rotation of the roller tube. As illustrated, several rotational synchronizers 100, 510, and 512 are installed on the inner shaft 3. The rotational synchronizer 100 is formed by mating a rotation adaptor (e.g., the rotation adaptor 1) with a rotation driver (e.g., the rotation driver 2). Two rotation adaptors 509 and 511 are fitted onto a shaft connector 71 to form the rotational synchronizers 510, and 512, respectively. The inner shaft 3 along with rotational synchronizers 100, 510, and 512 are installed into the outer tube 4. The outer tube 4 has two openings 41 and 42 at its two ends.

The electrical motor 7 is installed at the opening 41 and the tube plug 43 is installed at the opening 42. Support brackets 44 and 45 are used to install the roller tube 4 on a window as part of a roller shutter. The electrical motor 7 has a driving shaft 70 that is installed into the shaft connector 71 through the opening 41. Thus, when the electrical motor 7 provides the torque, the torque is conveyed to the inner shaft 3 through the driving shaft 70 and the shaft connector 71. Since the rotation synchronizers 100, 510, and 512 rotationally couple the inner shaft 3 with the outer tube 4, the torque can be applied evenly to the outer tube 4. Thus, unlike the roller shutter systems 200, 300, and 400, the rotation power source is connected to the inner shaft rather than the outer tube. Thus, the torque provided by the rotational power source is applied to the inner shaft 3 before being convey to the outer tube 4 via the rotation synchronizes.

As mentioned, the rotation synchronizers can be used to synchronize the roller operations of two roller shutters. For example, a first rotation synchronizer can be rotationally coupled to a first outer tube of a first roller shutter. A second rotation synchronizer can be rotationally coupled to a second outer tube of a second roller shutter. Both the first and second rotation synchronizers are installed at the inner shaft. Thus, the rotations of the two roller shutters are synchronized. In some embodiments, the inner shaft includes two or more separate sections. The different sections of the inner shaft are interconnected by one or more shaft extenders that convey the rotation of the inner shaft across the different sections. At least one rotation synchronizer is installed on each section of the inner shaft.

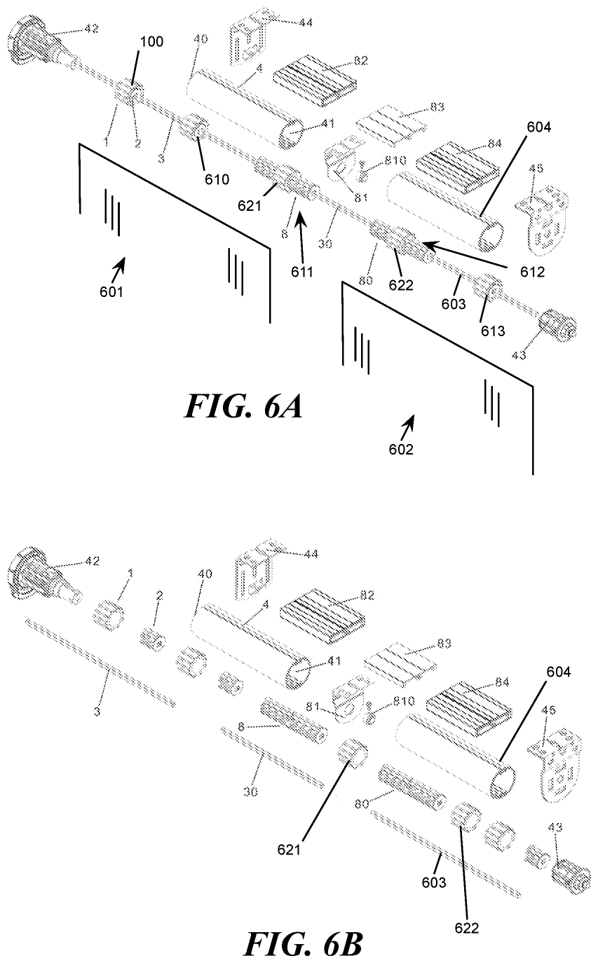

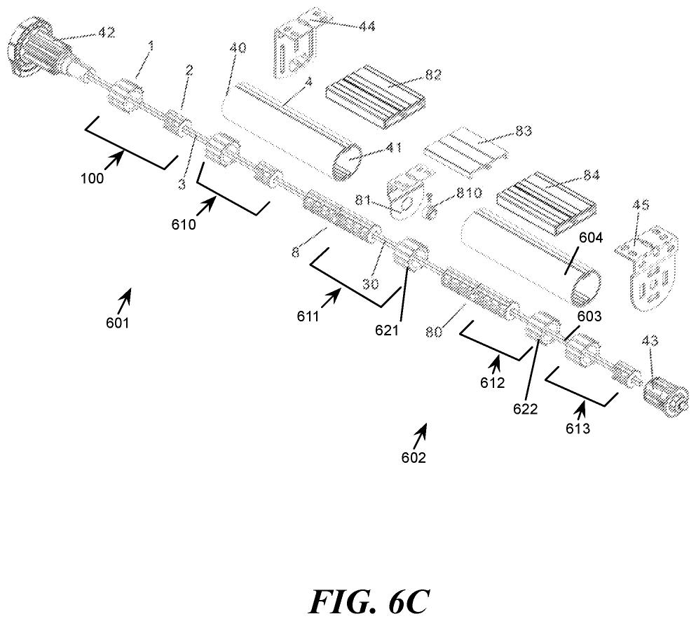

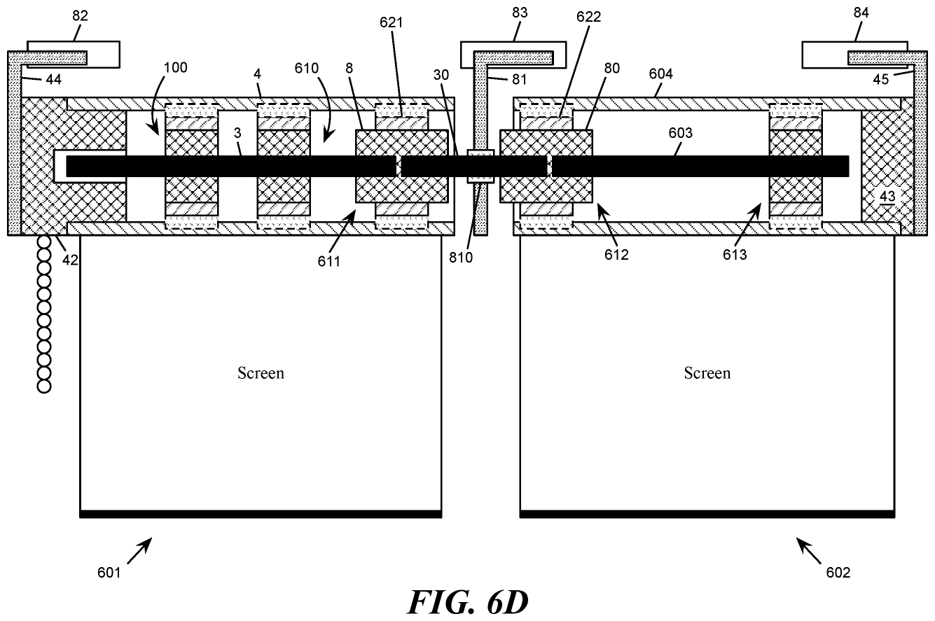

FIGS. 6A-6D illustrate two roller shutters that are synchronized by rotation synchronizers and the inner shaft. The figures illustrate a first roller shutter 601 having the roller tube 4 and a second roller shutter 602 having a roller tube 604. A first inner shaft section 3 is to be installed in the first roller tube 4 of the first roller shutter 601. A second inner shaft section 603 is to be installed in the second roller tube 604 of the second roller shutter 602. A third inner shaft section 30 is used to couple the first inner shaft section 3 and the second inner shaft section 603. A shaft extender 8 binds the first inner shaft section 3 with the third inner shaft section 30. A shaft extender 80 binds the second inner shaft section 603 with the third inner shaft section 30. A rotation power source 42 (a bead chain controller) is coupled to the first roller tube 4.

Multiple rotation synchronizers are used to synchronize the rotation of the roller tubes 4 and 604. As illustrated, the rotation synchronizers 100 and 610 are installed on the inner shaft section 3. The rotation synchronizer 613 is installed on the inner shaft section 603. Each of the rotation synchronizers 100, 610, and 613 are formed by fitting a rotation adaptor (e.g., the rotation adaptor 1) with a rotation driver (e.g., the rotation driver 2). The rotation synchronizers 611 and 612 are formed by fitting rotation adaptors 621 and 622 onto the shaft extenders (or rotation drivers) 8 and 80. The rotation synchronizers 100, 610, and 611 rotationally couple the inner shaft section 3 to the roller tube 4. The rotation synchronizers 612, 613 rotationally couple the inner shaft section 3 to the roller tube 604. Thus, the torque provided by the rotation power source 42 will be evenly conveyed to the roller tubes of both roller shutters 601 and 602. The torque is conveyed through the shaft sections and the rotation synchronizers that are formed by rotation adaptors that are fitted on drive connectors or shaft extenders. Torque provided by the rotation power source 42 will be conveyed to inner shaft section 3 through rotation synchronizers 100, 610, and 621. From the inner shaft section 3, torque is further conveyed to inner shaft sections 30 and 603 through the shaft extenders 8 and 80. The torque is also conveyed from the inner shaft section 30 and 603 to the second roller tube 604 via rotation synchronizers 612 and 613. The inner shaft 3 recesses into a round cavity in the bead chain controller 42, which allows the inner shaft 3 to freely rotate relative to the bead chain controller 42.

FIG. 6D also shows the components that are used to install the roller shutters 601 and 602. Specifically, support brackets 44, 45, and 81 are used to support the roller tubes 4 and 604 when the two roller shutters are installed. The support bracket 44 support the left end of the roller tube 4 and the support bracket 45 support the right end of the roller tube 604. The support bracket 81 support both roller tubes 4 and 604 by providing an aperture fitted with A shaft ring 810 for the inner shaft section 30 to go through. Mounting brackets 82, 83, and 84 are used to mount the support brackets 44, 81, and 45, respectively.

In the example of FIGS. 6A-D, inner shafts 3, 30, and 603 go through the entire lengths of both roller tubes 4 and 604 for synchronizing the two roller tubes. In some embodiments, the two roller tubes are rotationally synchronized by a shared inner shaft. This shared inner shaft is shortened. The shortened inner shaft is only long enough to provide torque from one a first rotation synchronizer in the first roller to a second rotation synchronizer in the second roller. It is not long enough run through the entire length of either roller tube.

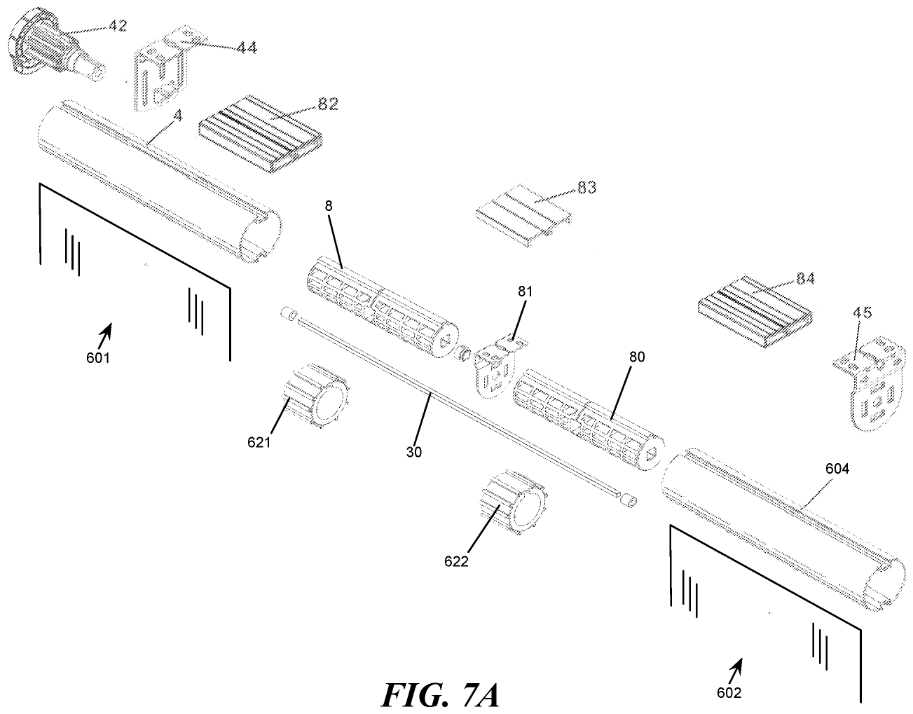

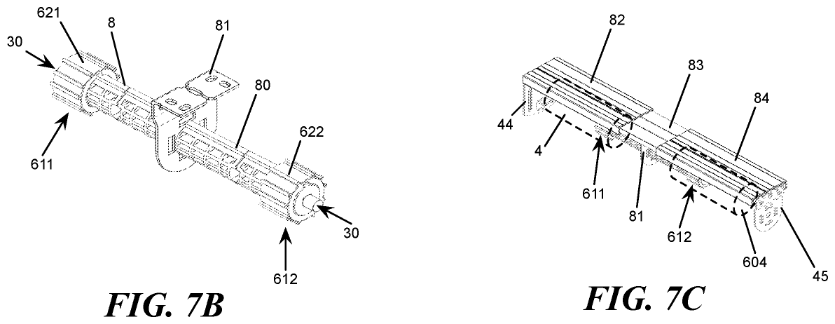

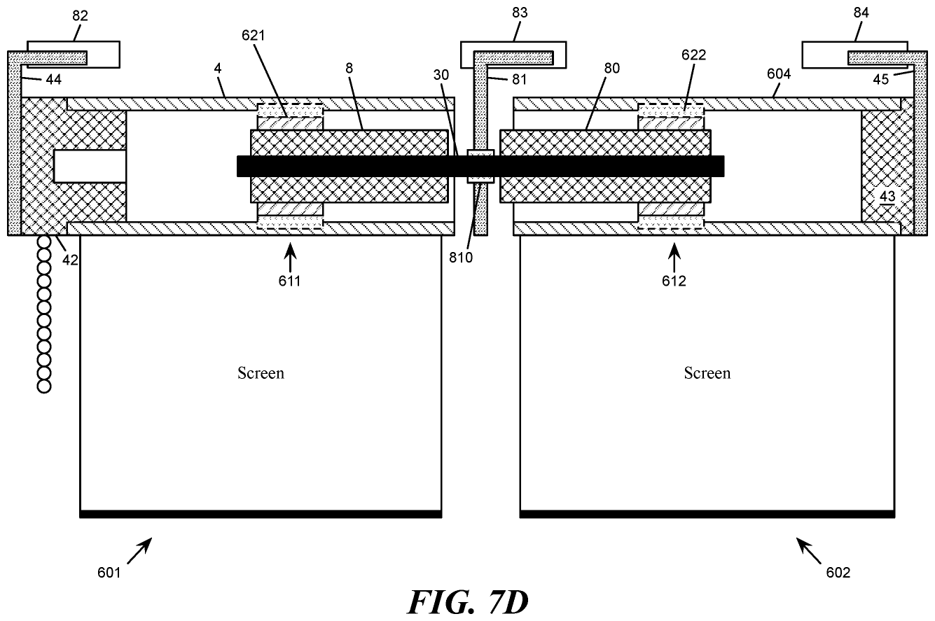

FIGS. 7A-7D illustrate two roller shutters that are synchronized by a shortened inner shaft. As illustrated, the first roller shutter 601 has the roller tube 4 and the second roller shutter 602 has the roller tube 604. One shortened inner shaft 30 rotationally couples the roller tube 4 with the roller tube 604 through rotation synchronizers 611 and 612. The rotation synchronizer 611 is formed by the rotation adaptor 621 and the rotation driver 8. The rotation synchronizer 612 is formed by the rotation adaptor 622 and the rotation driver 80. The rotation synchronizer 611 rotationally couples the outer tube 4 with the inner shaft 30, while the rotation synchronizer 612 rotationally couples the outer tube 604 with the inner shaft 30. A rotation power source 42 (a bead chain controller) is coupled to the roller tube 4. Thus, torque provided by the rotation power source 42 will be conveyed to the inner shaft 30 via the rotation synchronizer 611. The inner shaft 30 in turn conveys the torque to the outer tube 604 via the rotation synchronizer 612.

The length of the inner shaft 30 is such that the two ends of the inner shaft do not exceed halfway points of the outer tube 4 and of the outer tube 604. The inner shaft 30 also has only one section and not extended. The shortened length of the inner shaft reduces the weight and cost of the synchronized roller shutters. The length of the shortened inner shaft 30 may also be defined by the lengths and/or positions of the rotation drivers 8 and 80 (or rotation synchronizers 611 and 612). For example, the ends of the shorted inner shaft 30 may be flush or nearly flush with the left end of the rotation drivers 8 and the right end of the rotation driver 80. In the illustrated example, shaft plugs are installed at the two ends of the inner shaft 30 so to prevent the rotation drivers 8 and 80 from sliding off.

In some embodiments, the rotation synchronizers can be used to synchronize rotation of a roller that is used to perform lifting and/or tilting operations in a horizontal window blind (e.g., a venetian blind having horizontal slats). The cross-section of such a roller tube has a non-circular shape, such as triangular. Descriptions of horizontal window blinds that use roller tubes for lifting and/or tilting operations can be found in U.S. patent application Ser. No. 17/830,300, titled “WINDOW BLIND LIFTING AND TILTING SYSTEM”, filed on Jul. 15, 2022.

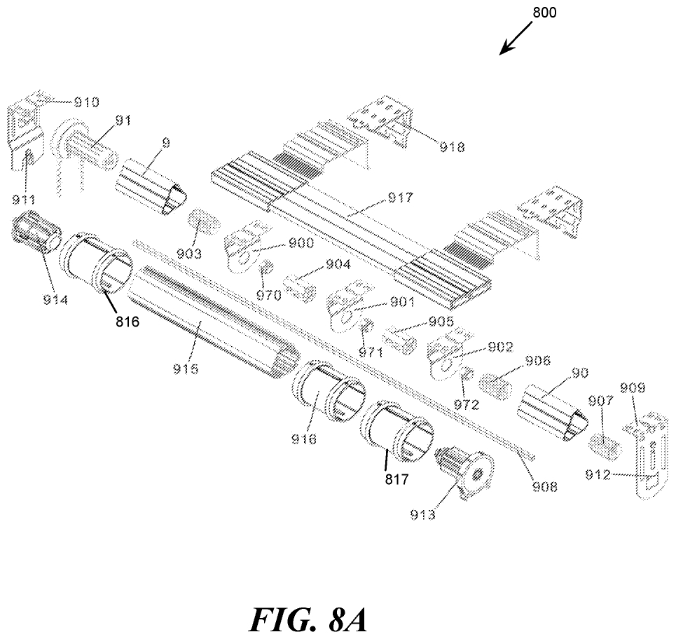

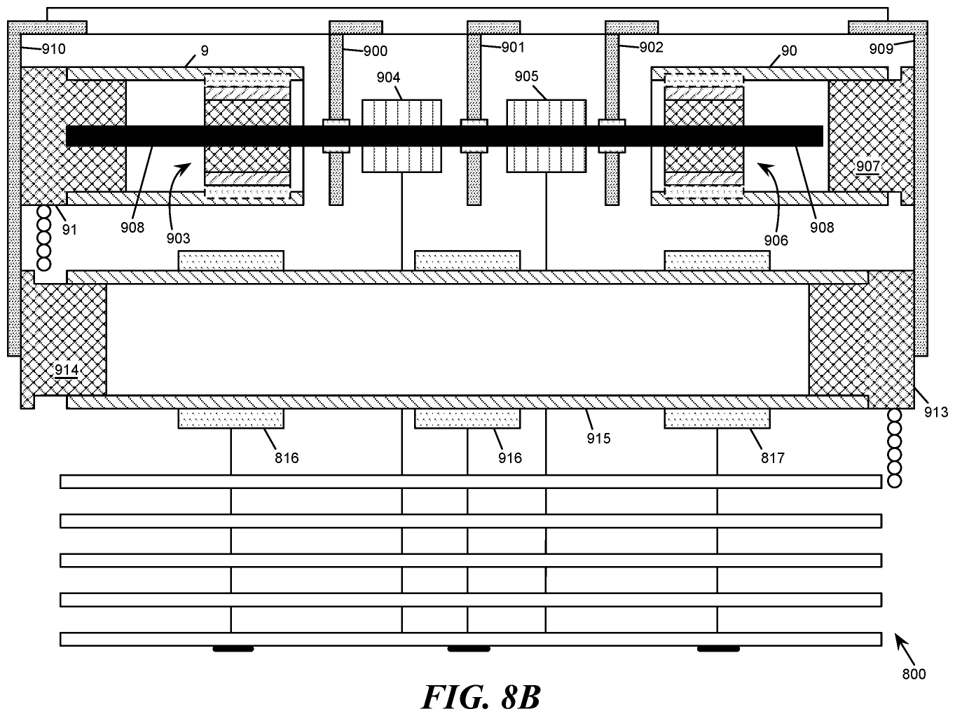

FIGS. 8A-8B illustrate a horizontal blind system 800 that uses rotation synchronizers to perform tilting operations. As illustrated, the horizontal blind system 800 has an inner shaft 908 that are rotationally coupled to two triangular outer tubes 9 and 90 for titling slats. Between the two triangular tubes are three support brackets 900, 901, and 902. Each support bracket has an aperture fitted with A shaft ring, so the support brackets 900, 901, and 902 has shaft rings 970, 971, and 972, respectively. A rotation synchronizer 903 is disposed at one end of the triangular tube 9. Slat tilting wheels 904 and 905 are positioned between the support brackets 900, 901, and 902. Rotation synchronizer 906 is disposed at the one end of the triangular tube 90. The slat tilting wheels 904 and 905 and the rotation synchronizers 903, 906 all have square-shaped central tunnels, which allows the inner shaft 908 to go through and become rotationally coupled. The inner shaft 908 also goes through support brackets 900, 901, 902 and their respective shaft rings 970, 971, and 972. The right end of the inner shaft 908 is supported by a support bracket 909. The left end of the inner shaft 908 is affixed to a bead chain controller 91 (for tilting slats), which is installed into the triangular tube 9 to drive the triangular tube's rotation. The bead chain controller 91 is affixed to a support bracket 910. When the user pulls on the chain of the bead chain controller 91, torque is generated and provided to rotate the triangular tube 9 and the inner shaft 908. The inner shaft 908 is rotationally coupled to the triangular tube 90 by the rotation synchronizers 903 and 906 to ensure synchronized, uniform rotation between the two triangular tubes 9 and 90. The inner shaft 90 is also rotationally coupled to the slat tilting wheels 904 and 905 so their rotations are also synchronized. The rotation adaptor of the rotation synchronizer 903 is shaped to fit the shape of the triangular tube 9.

In addition to supporting the inner shaft 908 and all components along it for tilting slats of the horizontal blind system 800, the support brackets 909 and 910 also support another rotating triangular tube 915 for lifting slats of the horizontal blind system 800. As illustrated, the bottoms of support brackets 909 and 910 have support aperture 911 and support plate 912, which are used to support a tube plug 914 and a bead chain controller 913 (for lifting slats). The tube plug 914 and the bead chain controller 913 in turn supports the triangular tube 915. The triangular tube 915 is fitted with three winding drums 916, 816, and 817 for winding lifting cords (for retracting and releasing slats). The support brackets 910 and 909 can mate with a support rail 917. The support rail 917 is mounted to a window by mounting brackets 918 to complete the installation of the horizontal blind system 800 to a window.

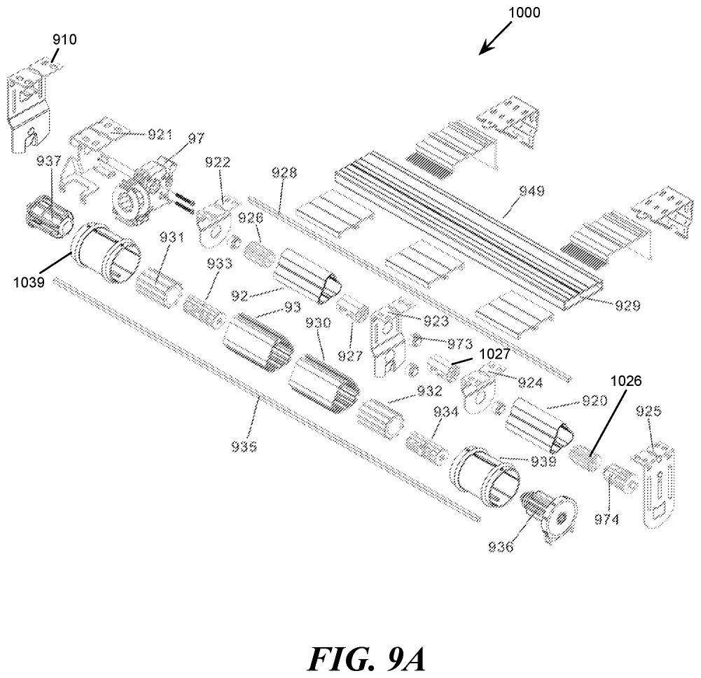

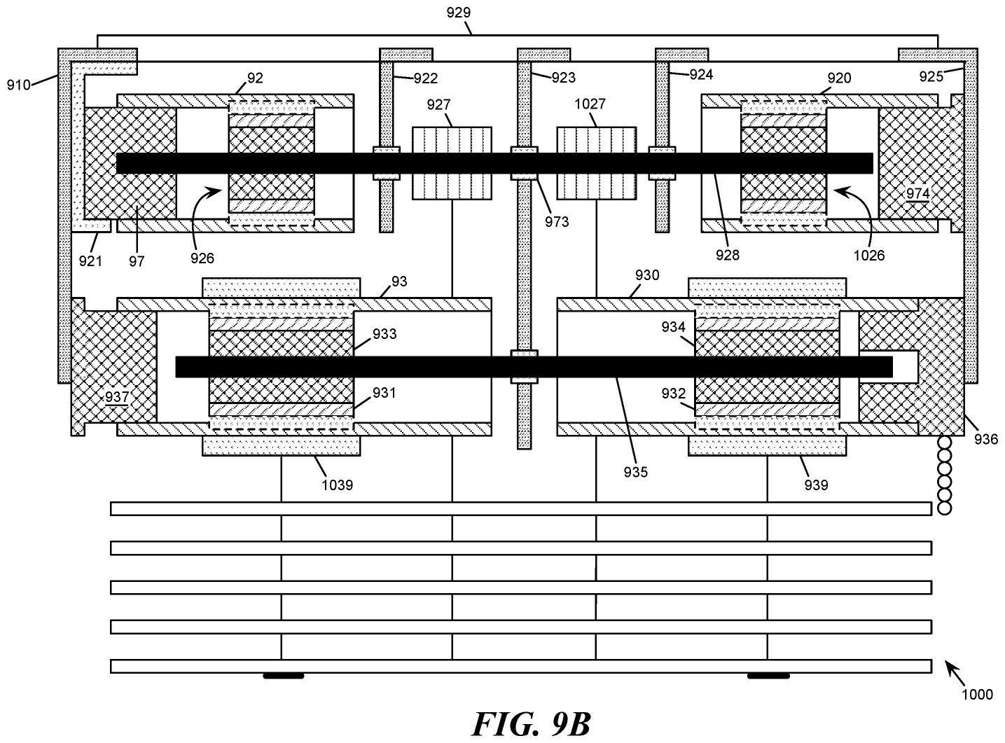

FIGS. 9A-9B illustrate horizontal blind system 1000 that uses two inner shafts to synchronize the rotations of both tilting and lifting operations. The horizontal blind system 1000 has a first inner shaft 928 for tilting and a second inner shaft 935 for lifting.

As illustrated, the first inner shaft 928 goes through support brackets 922-924 and triangular tubes 92 and 920. The inner shaft 928 is supported by shaft rings such as the shaft ring 973 that is fitted into an aperture of the central support bracket 923. The inner shaft 928 also goes through rotation synchronizers 926 and 1026 and slat tilting wheels 927 and 1027. The rotation synchronizer 926 is installed into the triangular tube 92 and the rotation synchronizer 1026 is installed into the triangular tube 920. A tube plug 974 is inserted into the triangular tube 920 so the triangular tube 974 can be supported by the support bracket 925. A support bracket 921 supports a tilting power driver 97. The titling power driver 97 is the rotation power source providing the torque for rotating the inner shaft 928, which also rotates the slat tilting wheels 927 and 1027 and the triangular tubes 92 and 920 via the rotation synchronizers 926 and 1026, in an even, synchronous manner. The assembly of the inner shaft 928 (including the triangular tubes, the tilting power driver, the rotation synchronizers, and the slat tilting wheels) is mounted to a window by a mounting rail 929 by the support brackets 910 and 921-925.

The horizontal blind system 1000 also includes triangular tubes 93 and 930 for lifting slats. As illustrated, rotation adaptors 931 and 932 and rotation drivers 933 and 934 are combined to form rotation synchronizers to be fitted within the triangular tubes 93 and 930. These components are installed on the second inner shaft 935, which is fitted through the rotation drivers 933 and 934 to rotationally couple with the triangular tubes 93 and 930. The inner shaft 935 is installed at its right end with a bead chain controller 936. A winding drum 939 is installed around the triangular tube 930 and a winding drum 1039 is installed around the triangular tube 93 for winding lifting cords (for retracting and releasing slats). The bead chain controller 936 is used to control the lifting operation of the horizontal bind 1000. It provides torque to rotate both the triangular tubes 93 and the triangular tube 930. Both triangular tubes 93 and 930 are rotationally coupled to the inner shaft 935 through the rotation adaptors 931 and 932 and rotation drivers 933 and 934. Thus, the torque of the bead chain controller 936 is delivered to the triangular tube 930, then to the inner shaft 935, then to the triangular tube 93. The assembly of the inner shaft 935 (including the triangular tubes, the bead chain controller, the rotation synchronizers, and the winding drums) is mounted by a mounting rail 929 to the window.

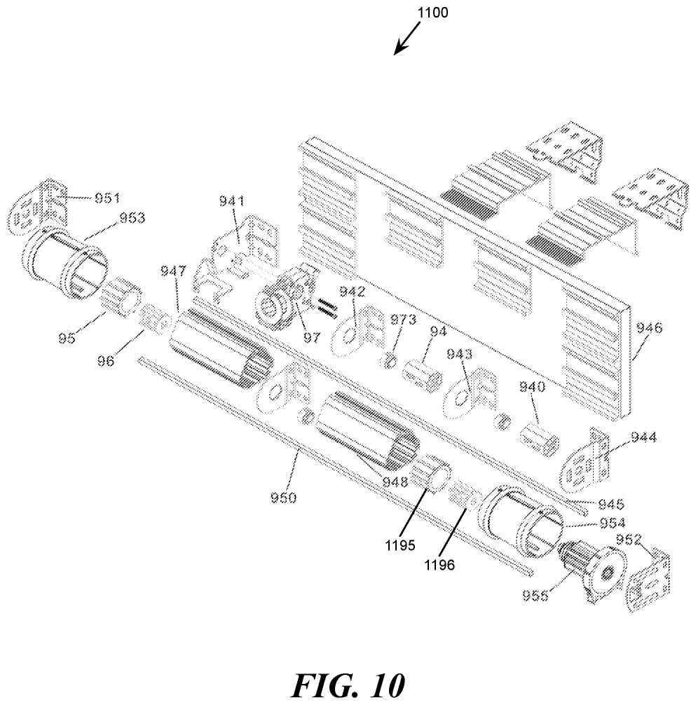

FIG. 10 illustrates another horizontal blind system 1100 that uses two inner shafts to synchronize the rotations of both tilting and lifting operations. The horizontal blind system 1100 has a first inner shaft 945 for tilting and a second inner shaft 950 for lifting.

As illustrated, the first inner shaft 945 goes through support brackets 941, 942, 943, and 944, and slat tilting wheels 94 and 940. The inner shaft 945 is supported by shaft rings such as the shaft ring 973 that is fitted into an aperture of the support bracket 942. The inner shaft 945 is also connected to a tilting power driver 97, which is supported by the support bracket 921. The titling power driver is the rotation power source providing the torque for rotating the inner shaft 945, which also rotates the slat tilting wheels 94 and 940 to control the tilting of slats in the horizontal blind 1100. The assembly of the inner shaft 945 (including the tilting power driver and the slat tilting wheels) is mounted to a wall 946 by the support brackets 941-944.

The second inner shaft 950 is rotationally coupled to triangular tubes 947 and 948 for lifting slats. Rotation adaptors 95 and 1195 and rotation drivers 96 and 1196 are combined to form rotation synchronizers to be fitted within the triangular tubes 947 and 948 so the rotation of the two triangular tubes can be synchronous and uniform. A winding drum 953 is installed around the triangular tube 947 and a winding drum 954 is installed around the triangular tube 948 for winding lifting cords (for retracting and releasing slats). The inner shaft 950 is installed at its right end with a bead chain controller 955 and at its left end with a tube plug (not illustrated). The bead chain controller 955 is used to control the lifting operation of the horizontal bind. It is a rotation power source that provides torque to rotate both the triangular tubes 947 and the triangular tube 948. The torque is delivered in a uniform, synchronous manner, as both triangular tubes 947 and 948 are rotationally coupled to the inner shaft 950 through the rotation adaptors 95 and 1195 and the rotation drivers 96 and 1196. Support brackets 951 and 952 are used to supports and mount the assembly of the inner shaft 950 (including the bead chain controller 955, the rotation synchronizers, the triangular tubes, the winding drums) to a wall mounting rail 946.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. An apparatus comprising:
an outer tube;
a rotation power source that provides power to rotate the inner shaft and the outer tube;
an inner shaft disposed within the outer tube; and
a rotation synchronizer that is installed at the inner shaft to rotationally couple the inner shaft with the outer tube.

2. The apparatus of claim 1, wherein the rotation synchronizer comprises a rotation adaptor and a rotation driver, wherein the rotation driver is configured to (i) recess into the rotation adaptor and (ii) receive the inner shaft.

3. The apparatus of claim 2, wherein the cross-section of the inner shaft is a square.

4. The apparatus of claim 2, wherein the rotation adaptor comprises tooths that abut the interior surface of the outer tube, wherein the rotation driver comprises a protrusion that mates with a crevice of the rotation adaptor.

5. The apparatus of claim 1, wherein two or more rotation synchronizers are installed at the inner shaft to rotationally couple the inner shaft with the outer tube at different positions of the outer tube such that the rotations at different positions of the outer tube are synchronized.

6. The apparatus of claim 1, wherein the inner shaft comprises two or more separate sections, wherein different sections of the inner shaft are interconnected by one or more shaft extenders that convey the rotation of the inner shaft across the different sections.

7. The apparatus of claim 6, wherein at least one rotation synchronizer is installed on each section of the inner shaft.

8. The apparatus of claim 1, wherein the rotation power source is installed at one end of the outer tube, and the torque provided by the rotation power source is conveyed to the inner shaft through the rotation synchronizer.

9. The apparatus of claim 1, wherein the rotation power source is installed at one end of the inner shaft, and the torque provided by the rotation power source is conveyed to the outer tube through the rotation synchronizer.

10. The apparatus of claim 1, wherein the rotation synchronizer is a first rotation synchronizer and the outer tube is a first outer tube of a first roller shutter, wherein a second rotation synchronizer is installed at the inner shaft and rotationally couples the inner shaft to a second outer tube of a second roller shutter such that the rotations of the first and second roller shutters are synchronized.

11. The apparatus of claim 10, wherein the ends of the inner shaft do not exceed halfway points of the first outer tube and of the second outer tube.

12. The apparatus of claim 1, wherein the outer tube is a roller for winding a screen of a roller shutter.

13. The apparatus of claim 1, wherein the outer tube is a roller for winding a cord that lifts slats of a horizontal blind.

14. The apparatus of claim 1, wherein the outer tube is a roller for winding a cord that tilt slats of a horizontal blind.
